(19) United States
(12) Patent Application Publication
(10) Pub. No.: US 2009/0307734 A1
(43) Pub. Date: Dec. 10, 2009

(54) COMMUNICATION DEVICE FOR PROVIDING COMMUNICATION BETWEEN ELECTRONIC APPARATUSES

(75) Inventors: Takashi DOI, Tokyo (JP); Hideki OHKITA, Tokyo (JP); Masahiko MAWATARI, Kanagawa (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/428,427

(22) Filed: Apr. 22, 2009

(30) Foreign Application Priority Data
Jun. 10, 2008 (JP) 2008-152163

(51) Int. Cl. H04N 7/173

(52) U.S. Cl. 725/105

(57) ABSTRACT

A communication device includes: a first communication module configured to perform a first communication with a counterpart communication device using a first set of communication lines; a second communication module configured to confirm with the counterpart communication device using a second set of communication lines whether the counterpart communication device is capable of establishing a second communication; a storage module configured to store information related to an extended communication capability provided in the counterpart communication device; and a controller configured to establish a third communication with the counterpart communication device based on the information stored in the storage module when the second communication module confirms that the counterpart communication device is capable of establishing the second communication.

### CROSS REFERENCE TO RELATED APPLICATION(S)

The present disclosure relates to the subject matters contained in Japanese Patent Application No. 2008-152163 filed on Jun. 10, 2008, which are incorporated herein by reference in its entirety.

### FIELD

The present invention relates to a communication device for providing communication between electric apparatuses.

### BACKGROUND

Recently, an HDMI (High Definition Multimedia Interface) standard has been utilized as a standard for a multimedia interface between video transmitting apparatuses such as a Digital Versatile Disk (DVD) player or a set top box and video receiving apparatuses such as a TV set or a monitor. An apparatus having an HDMI output terminal is referred to as a source apparatus while an apparatus having an HDMI input terminal is referred to as a sink apparatus. The video transmitting apparatuses are configured as the source apparatus and the video receiving apparatuses are configured as the sink apparatus. An apparatus having both the HDMI input terminal and the HDMI output terminal and being configured to serve as both the source apparatus and the sink apparatus is referred to as a repeater apparatus.

An HDMI communication device capable of performing communication according to the aforementioned HDMI standard is provided with a Transition Minimized Differential Signaling TDMS) transmission unit, a +5V power signal transmission unit, an Hot Plug Detect (HPD) signal transmission unit, an Extended Display Identification Data (EDID) transmission unit, an High-bandwidth Digital Content Protection (HDCP) authentication unit, and a Consumer Electronics Control (CEC) transmission unit.

The TMDS transmission unit transmits video, audio and auxiliary information. The +5V power signal transmission unit transmits a +5V power signal as a source ready signal to notify the sink or repeater apparatus that the connection is ready when the source apparatus is connected to the sink or repeater apparatus. The HPD signal transmission unit transmits an HPD signal as a sink ready signal indicating that the sink or repeater apparatus is ready for reception of video information. The EDID transmission unit transmits EDID as data including product information of the connected sink apparatus and a suitable video format. The HDCP authentication unit authenticates the sink apparatus. The CEC transmission unit transmits CEC which includes an apparatus control signal and a control protocol.

There has been proposed a communication system which is configured, while conforming to the data communication method conforming to the HDMI standard, so that data transmission from the sink apparatus to the source apparatus as well as data transmission from the source apparatus to the sink apparatus can be performed to make two-way high-speed communication possible. An example of such system is disclosed in JP-A-2007-311884.

In the communication system described in the publication JP-A-2007-311884, a communication module for performing a communication from a receiver to a transmitter is provided in at least one TMDS data channel so that time-division data transmission from the receiver to the transmitter can be performed in an unused interval where data transmission from the transmitter to the receiver is not performed.

The publication JP-A-2007-311884 describes that the thus configured communication system is capable of performing high-speed two-way communication while compatibility in data communication conforming to the HDMI standard can be kept by controlling both transmission timing from the transmitter to the receiver and transmission timing from the receiver to the transmitter.

The demand for transmission of a large-capacity video signal or the like has been increased in recent years with the advance of the speed of a communication network. Accordingly, it is conceivable that a situation arises where a novel HDMI communication device obtained by adding a new communication function to a conventional HDMI communication device is connected to another novel HDMI communication device or another conventional HDMI communication device through an HDMI cable while the connection form of an existing HDMI cable and an HDMI data transmission method are inherited. Example of such situation is described in the following document.

High-Definition Multimedia Interface Specification Version 1.3a

It is however impossible for a communication device to find beforehand which communication function the counterpart communication device has as a new communication function or whether or not the counterpart communication device is enabled to use the new communication function for communication, by only connecting the communication devices even when the communication devices are configured to be connectable to each other through a cable according to the conventional HDMI standard. For this reason, a situation may occur where the apparatuses cannot communicate with each other based on a new communication function although the apparatuses have the new communication function in common.

### SUMMARY

Therefore, one of objects of the invention is to provide a communication device configured to detect whether or not the counterpart communication device connected to the communication device through a cable has a new communication function other than an existing communication function.

According to a first aspect of the present invention, there is provided a communication device including: a first communication module configured to perform a first communication with a counterpart communication device to receive a video signal through a communication cable using a first set of communication lines provided in the communication cable; a second communication module configured to confirm with the counterpart communication device through the communication cable using a second set of communication lines provided in the communication cable whether the counterpart communication device is capable of establishing a second communication being a two-way communication; a storage module configured to store information related to an extended communication capability provided in the counterpart communication device, the extended communication capability being different from the first communication and the second communication; and a controller configured to establish a third communication with the counterpart communication device based on the information stored in the storage module when the second communication module confirms that the counterpart communication device is capable of establishing the second communication.

According to a second aspect of the present invention, there is provided a communication device including: a first communication module configured to perform a first communication with a counterpart communication device to receive a video signal through a communication cable using a first set of communication lines provided in the communication cable; a second communication module configured to perform a second communication, being a two-way communication, with the counterpart communication device through the communication cable using a second set of communication lines provided in the communication cable, the second communication module being capable of accessing an external storage module connected through the connection cable to read and write information related to an extended communication capability provided in the counterpart communication device, the extended communication capability being different from the first communication and the second communication; a controller configured to establish a third communication with the counterpart communication device based on the information accessed by the second communication module.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is an overall view showing an example of a data transmission system according to a first embodiment of the invention.

FIG. 2 is a block diagram schematically showing the data transmission system according to the first embodiment of the invention.

FIG. 3 is a view partially showing a data transmission path according to the first embodiment of the invention.

FIG. 4 is a view showing the configuration of data stored in an EDID memory.

FIG. 5 is a view showing communication commands based on additional functions.

FIG. 6 is a block diagram of a video receiver according to a second embodiment of the invention.

FIG. 7 is a view partially showing a data transmission path according to a third embodiment of the invention.

FIG. 8 is a view showing wave patterns of signals in a RSV line and a DDC line.

FIG. 9 is a view partially showing a data transmission path according to a fourth embodiment of the invention.

### DETAILED DESCRIPTION OF THE EMBODIMENTS

Hereinafter, embodiments of the invention will be described. In the following description, the same or similar components will be referenced by the same reference numerals, and detailed description thereof will be omitted.

In the following description, the concept ‘unused line’ means a reserved line (hereinafter referred to as RSV line) in an existing HDMI cable. The unused line is a line which is not used among the lines provided in the HDMI cable in the current HDMI standard. The concept ‘communication’ includes transmission and response of data and transmission of electrical power from one communication device to another communication device. The concept ‘additional function’ means a new function for communication different from existing communication which is executable in the current HDMI standard.

### First Embodiment

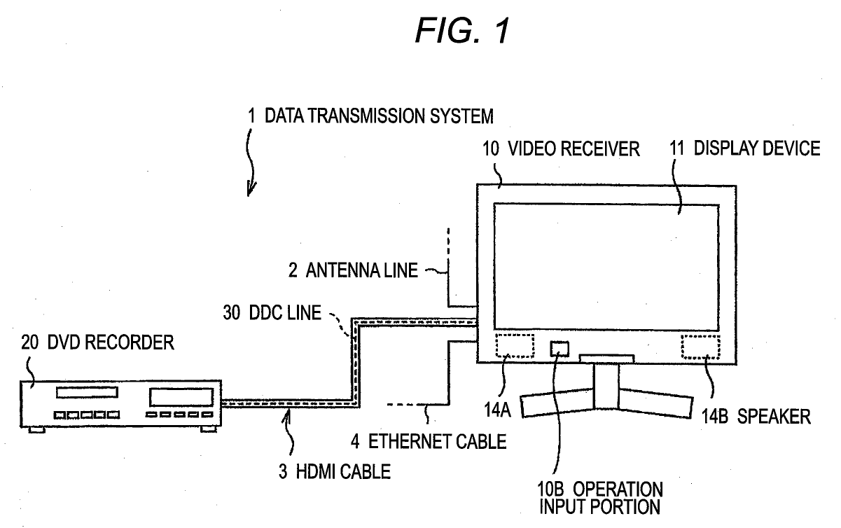

FIG. 1 is an overall view showing an example of a data transmission system according to a first embodiment of the invention.

The data transmission system 1 includes two communication devices which are connected to each other through an HDMI cable. Specifically, in this embodiment, the data transmission system 1 includes a video receiver (television) 10 serving as a sink apparatus, a DVD recorder 20 serving as a source apparatus, and an HDMI cable 3 through which the video receiver 10 and the DVD recorder 20 are connected to each other so that video and audio signals can be transmitted through one cable.

The video receiver 10 has an operation input portion 10B and speakers 14A and 14B in its front surface. The operation input portion 10B receives a remote control signal from a remote controller. The speakers 14A and 14B output audio. An antenna line 2 connected to an antenna and an Ethernet (registered trademark) cable 4 connected to an IP (Internet Protocol) communication network are connected to the video receiver 10.

When data based on video and audio of a DVD played back by the DVD recorder 20 is transmitted to the video receiver 10 through the HIMI cable 3, the video receiver 10 plays back the data. On the other hand, the video receiver 10 outputs video and audio based on a television broadcast signal received by the antenna connected to the antenna line 2. In addition, the video receiver 10 outputs video and audio based on Internet Protocol Television (IPTV) standard received through the Ethernet cable 4.

The HDMI cable 3 has a DDC line 30 which serves as a communication cable between the video receiver 10 and the DVD recorder 20. One communication device (i.e. one of the video receiver 10 and the DVD recorder 20) can confirm an additional function of the counterpart communication device through the DDC line 30 to thereby enable two-way communication based on the confirmed additional function. The DDC line 30 is provided as a serial bus including a data line and a clock line as a pair of lines according to the Inter Integrated Circuit (ICC) Standard.

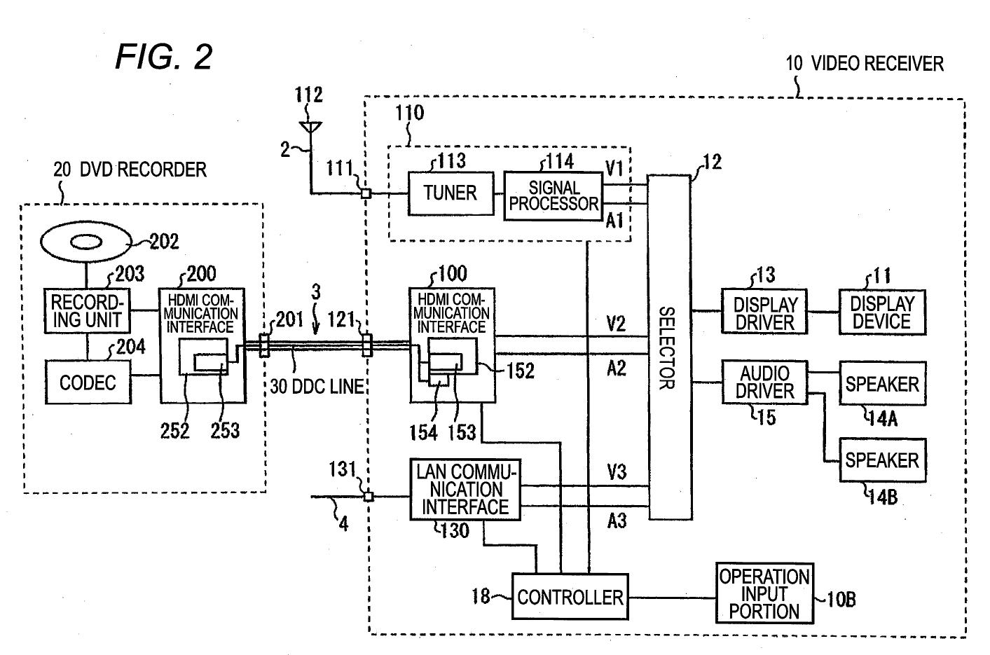

FIG. 2 is a block diagram schematically showing the data transmission system according to the first embodiment of the invention.

The video receiver 10 has a television broadcast receiver 110, an HDMI communication interface 100, an Local Area Network (LAN) communication interface 130, a selector 12, a display driver 13, an audio driver 15, and a controller 18. The television broadcast receiver 110 receives a television broadcast signal. The HDMI communication interface 100 receives a digital video signal conforming to the HDMI standard. The LAN communication interface 130 receives IPTV transmitted through the Ethernet cable 4. The selector 12 selects one from outputs of the television broadcast receiver 110, the HDMI communication interface 100 and the LAN communication interface 130. The display driver 13 drives a display device 11 to display video based on a video signal output from the selector 12. The audio driver 15 drives the speakers 14A and 14B to output audio based on an audio signal output from the selector 12. The controller 18 generally controls the respective portions of the video receiver 10.

The television broadcast receiver 110 has a tuner 113, and a signal processor 114. The tuner 113 receives a television broadcast signal by an antenna 112 connected to a TV (television) input terminal 111 through the antenna line 2 and extracts a signal of a required channel from the television broadcast signal. The signal processor 114 receives a reception signal output from the tuner 113 and restores the reception signal to a video signal V1 and an audio signal A1.

Upon reception of a digital video signal of the HDMI standard from an HDMI communication interface 200 of the DVD recorder 20 connected to a connector 121 through the HDMI cable 3, the HDMI communication interface 100 separates the digital video signal of the HDMI standard into video and audio components and outputs the video and audio components as a video signal V2 and an audio signal A2 respectively.

The HDMI communication interface 100 has a microcomputer 152, and an EDID memory 154. The microcomputer 152 includes a communication module 153 by which the HDMI communication interface 100 can communicate with the HDMI communication interface 200 through the DDC line 30. The EDID memory 154 is connected to the DDC line 30 of the HDMI cable 3. The EDID memory 154 stores data of coded display capability of the video receiver 10, data related to additional functions executable in the video receiver 10, data related to additional functions executable in the DVD recorder 20 and commands for execution of the additional functions. The EDID memory 154 stores the data and commands to be readable and rewritable.

The LAN communication interface 130 receives an IPTV broadcast signal through the Ethernet cable 4 connected to an LAN terminal 131, restores the reception signal to a video signal V3 and an audio signal A3 and outputs the video signal V3 and the audio signal A3.

The selector 12 is configured to perform selective switching among the video and audio signals V1 and A1 output from the television broadcast receiver 110, the video and audio signals V2 and A2 output from the HDMI communication interface 100 and the video and audio signals V3 and A3 output from the LAN communication interface 130, and to output the selected video and audio signals to the display driver 13 and the audio driver 15 respectively.

The DVD recorder 20 has an HDMI communication interface 200, a recording unit 203, and a codec 204. The HDMI communication interface 200 is connected to the HDMI communication interface 100 of the video receiver 10 through the HDMI cable 3 connected to a connector 201. The recording unit 203 performs recording data onto a recording medium 202, such as a DVD, and reading out data recorded on the recording medium 202. The codec 204 performs MPEG-decoding of encoded data supplied from the recording unit 203 into baseband video and audio signals and supplies the baseband video and audio signals to the HDMI communication interface 200. The recording unit 203 records encoded data output from the codec 204 and encoded data output from the HDMI communication interface 200.

The HDMI communication interface 200 has a microcomputer 252. The microcomputer 252 includes a communication module 253 by which the HDMI communication interface 200 communicates with the HDMI communication interface 100 through the DDC line 30.

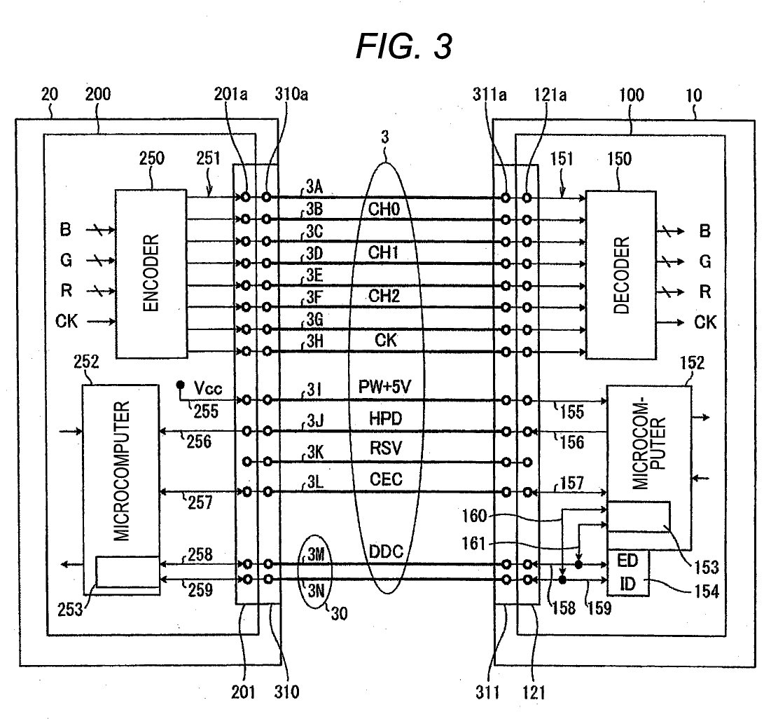

FIG. 3 is a view partially showing a data transmission path according to the first embodiment of the invention.

In the first embodiment, the sink apparatus has a first communication module for receiving a video signal as first communication through a communication cable (HDMI cable 3), a storage module (EDID memory 154) for storing information related to the function of the first communication, and a second communication module for performing communication with the storage module and the counterpart communication device as second communication through an IIC bus (DDC line 30) contained in the communication cable for connection to the storage module. The DDC line 30 is a communication line conforming to an IIC bus standard interface standard. The second communication module has a detection function, and a controller. The detection function of the second communication module detects whether third communication different from the first and second communications is enabled or not. The controller of the second communication module controls the third communication when the third communication is enabled. The microcomputer 152 provided in the sink apparatus according to the first embodiment is capable of serving as a master in communication through the IIC bus.

Preferably, this sink apparatus has a detection function of detecting whether or not the sink apparatus can perform the second communication with the counterpart communication device through the IIC bus. This detection function may use communication through an unused line (RSV line 30) provided in the communication cable.

In this embodiment, the data transmission path for connecting the source apparatus and the sink apparatus to each other is made by the source-side HDMI communication interface 200, the HDMI cable 3 and the sink-side HDMI communication interface 100.

The HDMI cable 3 has connectors 310 and 311. The connector 310 is connected to a connector 201 of the DVD recorder 20. The connector 310 has signal terminals 310a provided at one end portion of the HDMI cable 3 while the connector 201 has signal terminals 201a. The connector 311 is connected to a connector 121 of the video receiver 10. The connector 311 has signal terminals 311a provided at the other end portion of the HDMI cable 3 so as to be opposite to the connector 310 while the connector 121 has signal terminals 121a. The HDMI cable 3 includes first and second communication paths. The first communication path has signal lines 3A to 3F, and signal lines 3G and 3H. The signal lines 3A to 3F form differential signal lines through which the source apparatus can transmit video signals (inclusive of video and audio components) of three TMDS channels (Ch0, Ch1 and Ch2) to the sink apparatus. Pixel clocks synchronized with pixel data transmitted in the three TMDS channels are transmitted in a CK channel through the signal lines 3G and 3H. The second communication path has a PW+5V line 3I, an HPD line 3J, an RSV line 3K, a CEC line 3L, and a DDC line 30. The PW+5V line 3I and the HPD line 3J show a connection status of the HDMI cable 3. The RSV line 3K is an unused line. The CEC line 3L is used for controlling the status of each apparatus. The DDC line 30 includes a pair of lines 3M and 3N for transmission of EDID information, confirmation of additional functions of the counterpart communication device and transmission of commands for execution of the additional functions.

The first communication path is used for a first communication function by which an encoder 250 of the DVD recorder 20 transmits video signals and clocks for controlling the video signals to a decoder 150 of the video receiver 10 through signal lines 251, signal lines 3A to 3H of the HDMI cable 3 and signal lines 151 provided in accordance with the TMDS channels.

The second communication path is used for a second communication function which includes a function of connecting the communication module 153 of the video receiver 10 and the communication module 253 of the DVD recorder 20 to a storage area of the EDID memory 154, a function of controlling the communication module 153 or the communication module 253 to performing read and write with respect to the storage area of the EDID memory 154, and a function of performing two-way communication of commands transmitted by the communication module 153 and the communication module 253.

In the second communication function, the sink apparatus confirms whether two-way communication between the sink apparatus and the source apparatus can be made through the DDC line 30 or not, and confirms whether any additional function is provided or not when the two-way communication can be made. When the sink apparatus confirms an additional function common to the sink and source apparatuses, requests the source apparatus to execute the additional function and acquires a response to the request, the HDMI communication interface 200 of the source apparatus and the HDMI communication interface 100 of the sink apparatus are enabled to execute a third communication function (extended communication capability) which is based on the additional function and which is different from the first and second communication functions.

Examples of the third communication function include two-way communication of video signals based on frame-based Ethernet communication according to IEEE (Institute of Electrical and Electronics Engineers) 802.3, two-way communication of audio signals according to S/PDIF (Sony/Philips Digital Interface Format), and an electrical power supply function by which the sink apparatus supplies a larger amount of electrical power to the source apparatus. There are the case where the third communication function is performed via the DDC line 30 and the case where the third communication function is performed via another line such as the PW+5V line 3I than the DDC line 30.

The HDMI communication interface 200 has an encoder 250, signal lines 251, a microcomputer 252, and a communication module 253. The encoder 250 encodes video signals transmitted in the TMDS channels. The signal lines 251 are a plurality of lines for connecting terminals of the encoder 250 to the terminals of the connector 201 respectively. The microcomputer 252 is connected to the PW+5V line 3I, the HPD line 3J, the CEC line 3L and the DDC line 30. The communication module 253 is controlled by the microcomputer 252 and connected to the DDC line 30 through signal lines 258 and 259.

The microcomputer 252 has a signal processing circuit configured to execute the second communication function and the third communication function based on the additional function with respect to the video receiver 10 of the source apparatus. The microcomputer 252 is connected to the HPD line 3J through a signal line 256 and connected to the CEC line 3L through a signal line 257.

The HDMI communication interface 100 has a decoder 150, signal lines 151, a microcomputer 152, a communication module 153, and an EDID memory 154. The decoder 150 decodes video signals received in the TMDS channels. The signal lines 151 are a plurality of lines for connecting terminals of the decoder 150 to the terminals of the connector 121 respectively. The microcomputer 152 is connected to the PW+5V line 3I, the HPD line 3J, the CEC line 3L and the DDC line 30. The communication module 153 is controlled by the microcomputer 152 and connected to the DDC line 30 through a pair of signal lines 160 and 161. The EDID memory 154 is connected to the DDC line 30 through a pair of signal lines 158 and 159. The communication module 153 is formed to be connectable to the EDID memory 154 through the pair of signal lines 160 and 161 and the pair of signal lines 158 and 159.

The microcomputer 152 has a signal processing circuit configured to execute the second communication function and the third communication function based on the additional function with respect to the DVD recorder 20 of the sink apparatus. The microcomputer 152 is connected to the PW+5V line 3I through a signal line 155, connected to the HPD line 3J through a signal line 156, and connected to the CEC line 3L through a signal line 157.

According to the first embodiment, a communication path is formed so that the communication module 153 of the sink apparatus and the communication module 253 of the source apparatus are connected to each other through the DDC line 30 while the EDID memory 154 with stored information related to each additional function of the sink apparatus and each additional function of the source apparatus is connected to the DDC line 30.

In this manner, when the communication module 253 of the source apparatus serves as a master, the communication module 253 of the source apparatus is connected to the EDID memory 154 through the DDC line 30 to obtain the conventional apparatus information reading function such as display capability of the sink apparatus, each additional function, etc. stored in the EDID memory 154. Moreover, there is provided a function by which the sink and source apparatuses perform writing with respect to the stored additional function into the EDID memory 154. In addition, when the communication module 153 of the sink apparatus serves as a master, the communication module 153 of the sink apparatus reads apparatus information of the source apparatus stored in the EDID memory 154 to obtain a function by which the communication module 153 of the sink apparatus can communicate with the communication module 253 of the source apparatus via the DDC line 30 with respect to control information of the additional function when the additional function is common to the sink and source apparatuses.

The case where a plurality of masters perform read/write control with respect to a memory or the like on the IIC bus is referred to as multi-master. The masters satisfying the multi-master have arbitration functions to avoid access conflict. Only when the communication module 253 of the source apparatus is enabled to communicate via the DDC line 30 as a multi-master IIC bus, the communication module 153 of the sink apparatus can serves as a master to take the initiative in communication through the DDC line 30.

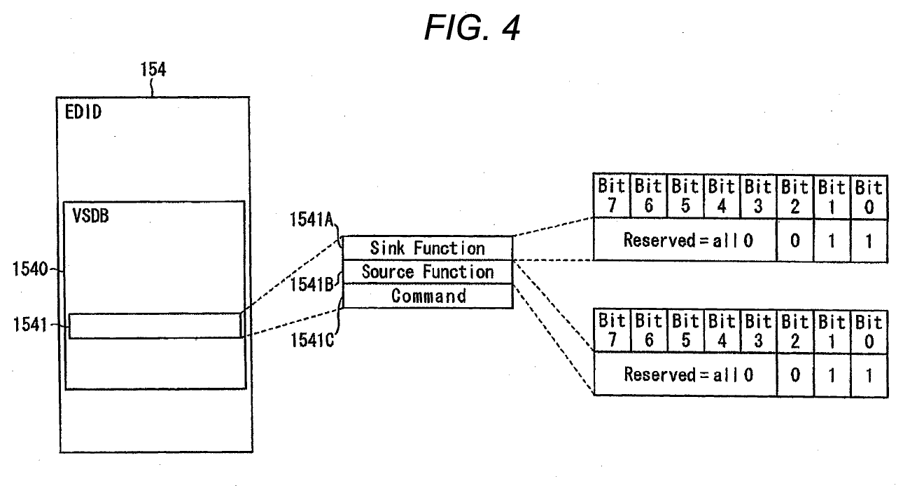

FIG. 4 is a view showing the configuration of data stored in the EDID memory.

The EDID memory 154 has a storage area 1541 related to communication through the DDC line 30 in a Vendor-Specific Data Block (VSDB) 1540. This storage area 1541 has a first storage area 1541A, a second storage area 1541B, and a third storage area 1541C. Information related to additional communication functions of the sink apparatus (Sink Function) is stored in the first storage area 1541A. Information related to additional communication functions of the source apparatus (Source Function) is stored in the second storage area 1541B. Commands related to communication are stored in the third storage area 1541C.

The first storage area 1541A further has an 8-bit storage area provided in accordance with each communication function. A bit corresponding to each communication function provided by the sink apparatus is set to “1”.

The second storage area 1541B further has an 8-bit storage area provided in accordance with each communication function in the same manner as the first storage area 1541A. A bit corresponding to each communication function provided by the source apparatus is set to “1”.

The first bit (Bit0) of each of the first storage area 1541A and the second storage area 1541B shown in FIG. 4 is a bit related to permission of Ethernet communication as an additional function. The second bit (Bit1) thereof is a bit related to permission of S/PDIF communication. The third bit (Bit2) thereof is a bit related to permission of power supply. The other bits are undefined and reserved.

In the first storage area 1541A, each of the first and second bits is set to “1”. The first bit of “1” indicates that the sink apparatus is enabled to perform Ethernet communication. The second bit of “1” indicates that the sink apparatus is enabled to perform S/PDIF communication.

In the second storage area 1541B, each of the first and second bits is set to “1”. The first bit of “1” indicates that the source apparatus is enabled to perform Ethernet communication. The second bit of “1” indicates that the source apparatus is enabled to perform S/PDIF communication.

The third storage area 1541C is a 1-byte storage area into which a command output from the source and sink apparatuses is written based on communication executed based on each additional function. The precise form (not shown) of the third storage area 1541C is ordinarily disposed both in the communication module 153 of the sink apparatus and in the communication module 253 of the source apparatus.

The source apparatus needs to write the respective bits of the second storage area 1541B to express each additional function of the source apparatus. Moreover, the source apparatus needs to read and confirm the respective bits of the first storage area 1541A before execution of the command written into the third storage area 1541C based on the additional function. The sink apparatus needs to read and confirm the respective bits of the second storage area 1541B before execution of the command written in the third storage area 1541C based on the additional function. Moreover, when the counterpart communication device does not have any additional function, the bit related to each additional function is “0”. In this case, the source and sink apparatuses cannot write any command related to the additional function into the third storage area 1541c.

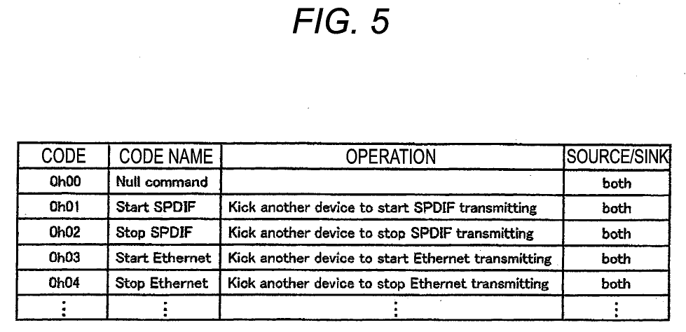

FIG. 5 is a view showing communication commands based on the additional functions.

Each command is provided as an 8-bit code. An operation of contents corresponding to the name of the command is performed. When, for example, the communication module 153 of the video receiver 10 shown in FIG. 1 transmits a command “Oh01” to request start of S/PDIF communication, the code “Oh01” is written in the address of the third storage area 1541C in the EDID memory 154 connected to the DDC line 30, and received by the communication module 253 of the DVD recorder 20 via the DDC line 30 of the HDMI cable 3. Both source and sink apparatuses can transmit this code “Oh01”. In the example shown in FIG. 5, contents of commands are as follows.

The code “Oh00” shows a command which has a code name “Null command” and which can be transmitted by the source and sink apparatuses. This command is used for invalidating or resetting running communication.

The code “Oh01” shows a command which has a code name “Start SPDIF” and which can be transmitted by the source and sink apparatuses. This command is used for notifying the counterpart communication device of the start of SPDIF communication as an example of the third communication.

The code “Oh02” shows a command which has a code name “Stop SPDIF” and which can be transmitted by the source and sink apparatuses. This command is used for notifying the counterpart communication device of the stop of SPDIF communication as an example of the third communication.

The code “Oh03” shows a command which has a code name “Start Ethernet” and which can be transmitted by the source and sink apparatuses. This command is used for notifying the counterpart communication device of the start of Ethernet (registered trademark) communication as an example of the third communication.

The code “Oh04” shows a command which has a code name “Stop Ethernet” and which can be transmitted by the source and sink apparatuses. This command is used for notifying the counterpart communication device of the stop of Ethernet communication as an example of the third communication.

When there is an additional function (e.g. an electrical power supply function by which the sink apparatus supplies electrical power to the source apparatus via the HDMI cable as will be described later in other embodiments) which is different from SPDIF communication and Ethernet communication in terms of commands and which can be executed by the source and sink apparatuses, the source and sink apparatuses can perform communication corresponding to the additional function as long as there is a command corresponding to the additional function and the source and sink apparatuses can interpret a code corresponding to the command. In accordance with contents of the command, there are the case where both source and sink apparatuses can transmit the command, the case where only the source apparatus can transmit the command, and the case where only the sink apparatus can transmit the command.

Operation in the data transmission system according to the first embodiment will be described below with reference to the drawings.

As shown in FIG. 1, when both the video receiver 10 and the DVD recorder 20 connected to each other by the HDMI cable 3 are powered on so that the respective portions of both can operate normally, the communication module 253 of the DVD recorder 20 is connected to the EDID memory 154 of the video receiver 10 through the DDC line 30 at any timing to perform writing related to the stored additional functions into the EDID memory 154. In the EDID memory 154, a corresponding bit of the second storage area 1541B is set to “1” by means of writing of the communication module 253.

Then, the communication module 153 of the video receiver 10 is connected to the EDID memory 154 through the DDV line 30 at any timing to confirm data of the second storage area 1541B.

In this first embodiment, as shown in FIG. 4, the DVD recorder 20 has a bit set to “1” expressing Ethernet communication as an additional function while the video receiver 10 has a bit set to “1” expressing Ethernet communication as an additional function. Accordingly, the communication module 153 of the video receiver 10 requests the communication module 253 of the DVD recorder 20 to perform Ethernet communication through the DDC line 30.

Upon reception of the Ethernet communication request from the communication module 153 of the video receiver 10, the communication module 253 of the DVD recorder 20 sends a response for permission of Ethernet communication to the communication module 153 of the video receiver 10 through the DDC line 30.

Upon reception of the response from the communication module 253 of the DVD recorder 20, the communication module 153 of the video receiver 10 starts Ethernet communication through the DDC line 30 at predetermined timing. In the Ethernet communication, a command transmitted to the DDC line 30 by each of the communication module 153 and the communication module 253 is also stored in the third storage area 1541C of the EDID memory 154. When, for example, the communication module 253 of the DVD recorder 20 transmits the command “Oh04” to request the stop of Ethernet communication, the communication module 153 of the video receiver 10 stops Ethernet communication in response to the request.

According to the aforementioned first embodiment, confirmation is made as to whether the source and source apparatuses connected to each other by the HDMI cable 3 are enabled to perform two-way communication or not. When the source and sink apparatuses are enabled to perform two-way communication and have an additional function as well as the conventional communication function, two-way communication between the source and sink apparatuses is performed via the DDC line 30 according to the IIC bus specification as to what is the additional function so that the two-way communication between the source and sink apparatuses can be achieved based on the additional function without addition of any new configuration while connection compatibility of the HDMI cable 3 can be maintained.

Although the first embodiment has been described about an example where Ethernet communication is configured to be executable between the video receiver 10 and the DVD recorder 20 connected to each other by the HDMI cable 3, the first embodiment may be applied to S/PDIF communication. Accordingly, both additional functions of Ethernet communication and S/PDIF communication are configured to be executable.

Although description has been made on the case where information related to additional functions of the source and sink apparatuses is stored in the EDID memory 154, information related to the additional functions may be stored in another storage module than the EDID memory 154 as long as the storage module has a storage area where operable addresses can be defined according to the IIC bus specification.

Although the aforementioned first embodiment has been described on the case where two-way communication through the DDC line 30 is performed based on the HDMI cable, communication between apparatuses connected by a DVI cable etc. other than the HDMI cable or between apparatuses connected by a DisplayPort cable can be performed based on the additional function similarly by the aforementioned method.

Although the first embodiment has been described on the configuration in which the video receiver 10 and the DVD recorder 20 are HDMI communication devices having additional functions, there may be the case, in terms of connection mode, where one of the source and sink apparatuses is a conventional HDMI communication device and the other thereof is a new HDMI communication device having additional functions. When, for example, the DVD recorder 20 as the source apparatus is a conventional HDMI communication device and the video receiver 10 as the sink apparatus is a new HDMI communication device having additional functions, the communication module 253 never writes information related to the additional functions into the second storage area 1541B of the EDID memory 154 via the DDC line 30. In this case, since the communication module 153 of the video receiver 10 cannot communicate with the communication module 253, communication is performed according to HDMI cable connection between conventional HDMI communication devices.

### Second Embodiment

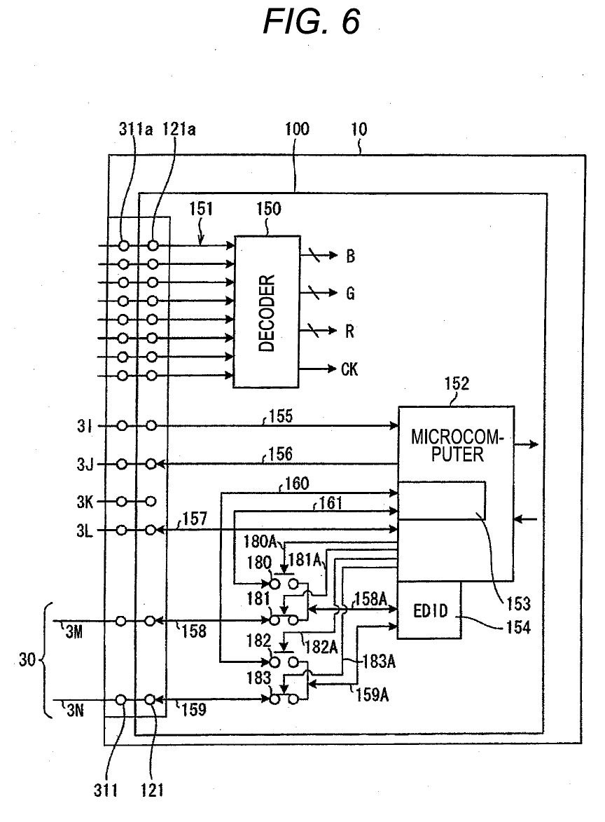

FIG. 6 is a block diagram of a video receiver according to a second embodiment of the invention. In the following description, respective portions in the second embodiment which are the same in configuration and function as those in the first embodiment will be referred to by the same numerals.

The second embodiment shows a specific configuration of a sink apparatus having an EDID memory 154, and a communication module 153 connected to the EDID memory 154 and a DDC line 30.

An HDMI communication interface 100 has switches 180 to 183 by which signal lines 160 and 161 connected to the communication module 153 are connected to either or both of the DDC line 30 and the EDID memory 154. A microcomputer 152 performs ON/OFF control of the switches 180 to 183 through signal lines 180A to 183A respectively. First to third states based on operation of the switches 180 to 183 will be described below.

The first state is a condition in which the communication module 153 shown in FIG. 6 is disconnected from the EDID memory 154. The microcomputer 152 turns OFF the switches 180 and 182 and turns ON the switches 181 and 183 so that a communication module of a source apparatus is connected to the EDID memory 154 through signal lines 3M and 3N of the DDC line 30, signal lines 158 and 159 and signal lines 158A and 159A. Ordinarily, the communication module 153 is set in the first state.

The second state is a condition in which the communication module 153 is connected to the EDID memory 154. The microcomputer 152 turns ON the switches 180 and 182 and turns OFF the switches 181 and 183 so that the communication module 153 is connected to the EDID memory 154 through the signal lines 160 and 161 and the signal lines 158A and 159A.

The third state is a condition in which the communication module 153 is connected to the DDC line 30. The microcomputer 152 turns ON the switches 180, 181, 182 and 183 so that the communication module 153 is connected to the signal lines 3M and 3N of the DDC line 30 through the signal lines 160 and 161 and the signal lines 158 and 159. On this occasion, the signal lines 158 and 159 are connected to the signal lines 158A and 159A respectively so that the communication module 153 is also connected to the EDID memory 154.

According to the aforementioned second embodiment, the HDMI communication interface 100 having the EDID memory 154 is configured so that connection of the communication module 153 to the DDC line 30 and connection of the communication module 153 to the EDID memory 154 are performed based on turning on/off of the switches 180 to 183. That is, in the first state, the communication module 253 of the source apparatus writes respective bits in the second storage area 1541B of the EDID memory 154. Then, in the second state, the communication module 153 of the sink apparatus reads the respective bits from the second storage area 1541B and confirms additional functions of the source apparatus. Then, the communication module 153 is set in the third state. Accordingly, when neither the additional function nor the multi-master is supported by the source apparatus, the sink apparatus can determine this state of the source apparatus.

### Third Embodiment

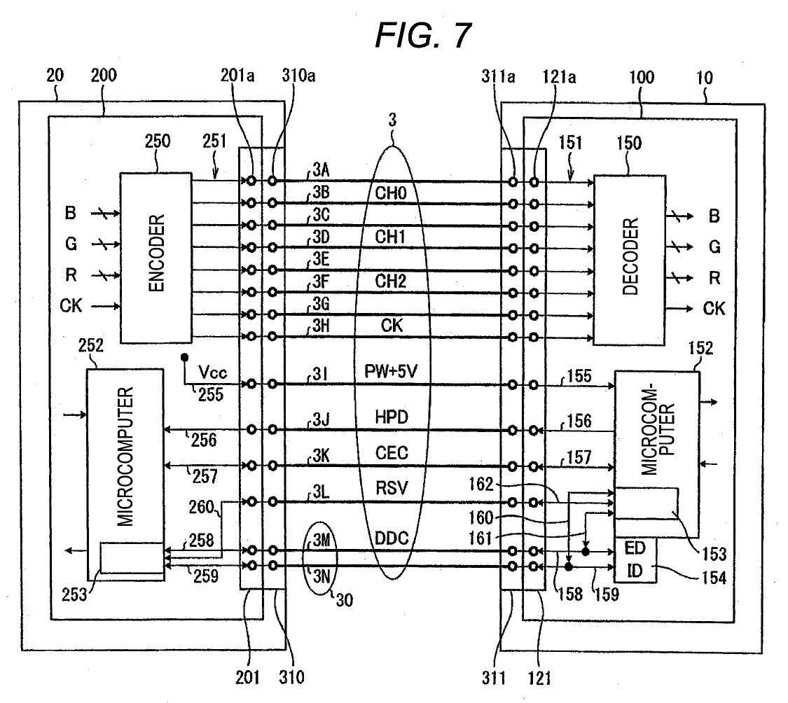

FIG. 7 is a view partially showing a data transmission path according to a third embodiment of the invention. In the following description, respective portions in the third embodiment which are the same in configuration and function as those in the first embodiment are referred to by the same numerals.

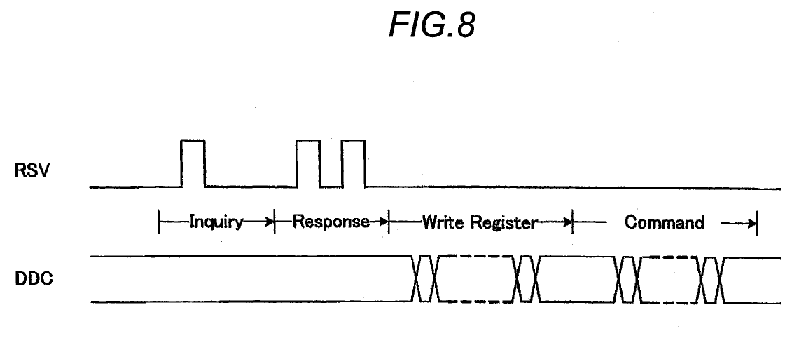

FIG. 8 is a view showing an example of wave patterns of signals in an RSV line and a DDC line.

When all additional functions are inactive, an inquiry and a response may occur in order to establish two-way communication through the DDC line 30 according to the IIC bus specification. The source apparatus may make an inquiry by a single pulse or the sink apparatus may make a response by a single pulse after the inquiry. Alternatively, the sink apparatus may make an inquiry by two pulses or the source apparatus may make a response by two pulses after the inquiry.

When there is a response, the communication module 253 of the source apparatus writes and registers (Write Register) the stored additional functions into the second storage area 1541B of the VSDB 1540 of the EDID memory 154 shown in FIG. 4. In this manner, it is possible to output a trigger for the additional functions written in the second storage area 1541B. When there is no response, the communication module 253 does not write the additional functions into the second storage area 1541B.

After the time period labeled “Write Register” in FIG. 8, both source and sink apparatuses serve as masters to transmit a command to each other so that two-way communication can be executed.

The third embodiment has not only the configuration described in the first embodiment but also the configuration in which one end of an RSV line 3L of an HDMI cable 3 is connected to a communication module 253 of a DVD recorder 20 through a signal line 260 while the other end of the RSV line 3L is connected to a communication module 153 of a video receiver 10 through a signal line 162 so that confirmation can be made through the RSV line 3L as to whether the communication module 253 described in the first embodiment has a two-way communication function or not.

The communication module 153 of the video receiver 10 transmits a first trigger to the communication module 253 of the DVD recorder 20 via the RSV line 3L at any timing to confirm whether the communication module 253 has a two-way communication function or not.

When the communication module 253 of the DVD recorder 20 has a two-way communication function, the communication module 253 transmits a second trigger to the communication module 153 of the video receiver 10 via the RSV line 3L in response to the received first trigger, and at the same time, writes respective bits into the second storage area 1541B of the EDID memory 154 so that information related to additional functions of the source apparatus is stored in the second storage area 1541B. When the second trigger is received by the communication module 153 of the video receiver 10 within a predetermined time after transmission of the first trigger, the video receiver 10 determines that the communication module 253 of the DVD recorder 20 has a two-way communication function. Then, confirmation of the additional functions and communication based on the additional functions are performed between the video receiver 10 and the DVD recorder 20 in the same manner as described in the first embodiment.

On the other hand, when the communication module 253 of the DVD recorder 20 is a communication module which does not respond to the first trigger within the predetermined time, the video receiver 10 determines that the DVD recorder 20 is a conventional HDMI communication device, so that communication is performed according to HDMI cable connection between conventional HDMI communication devices.

According to the aforementioned third embodiment, whether the counterpart communication device connected by the HDMI cable 3 is enabled to perform two-way communication through the DDC line 30 or not and whether the counterpart communication device is a new HDMI communication device having a two-way communication function different from the first communication function or not can be determined easily and quickly based on a response to a trigger transmitted through the RSV line 3L, in addition to the preferred effect of the first embodiment.

### Fourth Embodiment

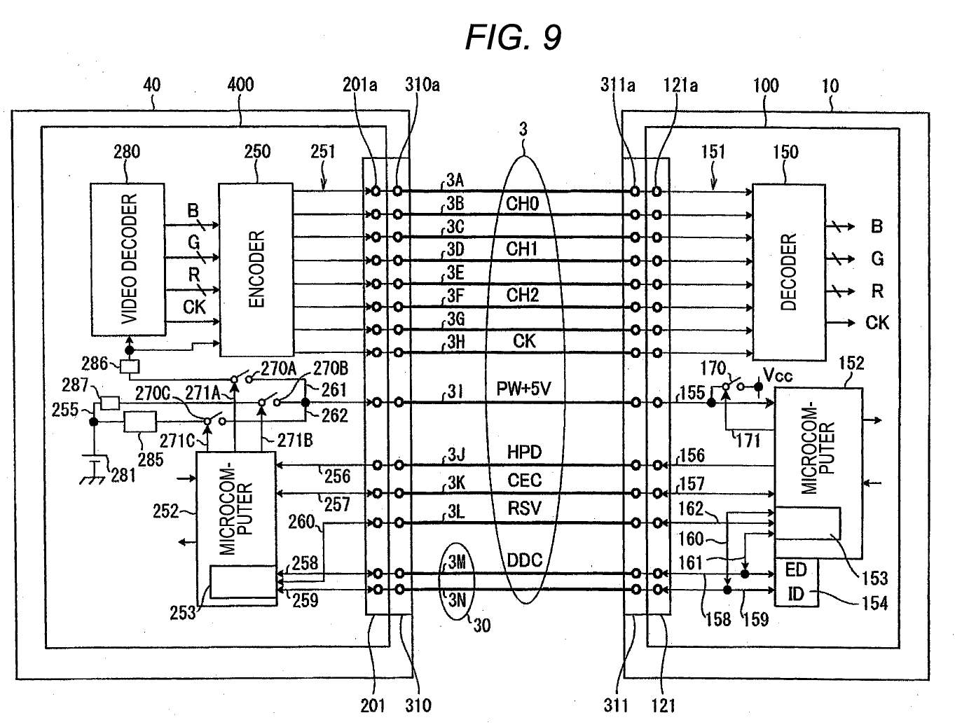

FIG. 9 is a view partially showing a data transmission path according to a fourth embodiment of the invention. In the following description, respective portions in the fourth embodiment which are the same in configuration and function as those in the third embodiment will be referred to by the same numerals.

The fourth embodiment shows, in addition to the configuration described in the third embodiment, the configuration in which the sink apparatus can execute a function of supplying electrical power to the source apparatus. The source apparatus is a video receiver 10 and the source apparatus is a digital camera 40 which operates based on electrical power of a built-in battery 281.

The digital camera 40 has an HDMI communication interface 400. The HDMI communication interface 400 has a video decoder 280, a battery 281, a charging portion 285, a stabilizing circuit portion 286, and a boosting circuit portion 287. The video decoder 280 outputs a video signal of still pictures, motion pictures, etc. to an encoder 250. The battery 281 is a lithium ion battery or the like which is a chargeable power supply for driving the digital camera 40. The charging portion 285 electrically charges the battery 281. The stabilizing circuit portion 286 stabilizes electrical power supply capability. The boosting circuit portion 287 adds 5V to a PW+5V line 3I. The battery 281 can supply 5V electrical power to the respective portions of the digital camera 40. Description of an image pickup processing portion, a video compression processing portion and a memory portion as ordinary functions of the digital camera will be omitted for the sake of simplification of description.

In the digital camera 40, the battery 281 is connected to the PW+5V line 3I through a signal line 255 having a switch 270B, and a signal line 261 branching from the signal line 255 is connected to the video decoder 280 and the encoder 250 through a switch 270A. Another signal line 262 branching from the signal line 255 is connected to the charging portion 285 through a switch 270C. A microcomputer 252 is configured to operate the switch 270A through a signal line 271A, operate the switch 270B through a signal line 271B and operate the switch 270C through a signal line 271C.

The video receiver 10 has, in addition to the configuration described in the third embodiment, the configuration in which an HDMI communication interface 100 has a switch 170 by which a voltage source Vcc is connected to a signal line 155 connected to the PW+5V line 3I. This switch 170 is operated by a microcomputer 152 through a signal line 171. When the switch 170 is turned ON so that the signal line 155 is connected to the voltage source Vcc, the voltage source Vcc supplies electrical power to the PW+5V line 3I.

In the fourth embodiment, when the switch 270B is turned ON by the microcomputer 252, the battery 281 supplies 5V electrical power to the PW+5V line 3I. Thus, the HDMI communication interface 400 of the digital camera 40 transmits a source ready signal to the HDMI communication interface 100 of the video receiver 10.

Upon reception of the source ready signal, the microcomputer 152 of the HDMI communication interface 100 transmits an HPD signal as a sink ready signal to an HPD line 3J via a signal line 156.

Upon reception of the HPD signal through a signal line 256 connected to the HPD line 3J, the HDMI communication interface 400 transmits a video signal input from the video decoder 280 to the encoder 250, via TMDS channels. On this occasion, the communication module 253 reads the display capability of a display device 11 stored in an EDID memory 154 of the HDMI communication interface 100, through a DDC line 30 of an HDMI cable 3 so that the display size of the transmitted video signal is set to a size displayable in the display device 11 of the video receiver 10.

The HDMI communication interfaces 100 and 400 confirm via the RSV line 3L whether two-way communication through the DDC line 30 can be made or not, and further confirm whether a function of supplying electrical power from the sink apparatus to the source apparatus is provided as an additional function or not. Therefore, the communication module 253 of the HDMI communication interface 400 transmits a request to the communication module 153 of the HDMI communication interface 100 through the DDC line 30 to supply 5V electrical power.

The microcomputer 152 of the HDMI communication interface 100 turns ON the switch 170 based on the request from the HDMI communication interface 400 to thereby connect the voltage source Vcc to the PW+5V line 3I through the signal line 155. Thus, the sink apparatus can supply 5V electrical power to the PW+5V line 3I.

When the amount of power supplied to the PW+5V line 3I becomes large, the microcomputer 252 of the HDMI communication interface 400 turns ON the switch 270A through the signal line 271A. Thus, 5V electrical power is supplied to the video decoder 280 and the encoder 250 through the PW+5V line 3L with the large amount of supplied electrical power.

The microcomputer 252 of the HDMI communication interface 400 turns ON the switch 270C through the signal line 271C. Thus, 5V electrical power is supplied to the charging portion 285 through the PW+5V line 3I with the large amount of supplied power so that the battery 281 is electrically charged.

According to the aforementioned fourth embodiment; a third communication function is provided in addition to the preferred effect of the third embodiment so that electrical power is supplied from the sink apparatus to the source apparatus through the HDMI cable 3 to thereby prevent communication failure from being caused by electrical power shortage in an HDMI communication device driven by a battery. In addition, in the case of an HDMI communication device having a charging portion for electrically charging a battery, the battery can be electrically charged with electrical power supplied stably from the sink apparatus.

Although the fourth embodiment has been described on the case where the video receiver 10 as the sink apparatus is configured so that the signal line 155 connected to the PW+5V line 3I is connected to the voltage source Vcc to thereby supply 5V electrical power to the PW+5V line 3I, the source apparatus may be configured so that the PW+5V line 3I can be connected to the voltage source Vcc to increase the amount of 5V electrical power supplied to the PW+5V line 3I in response to a command request on the sink apparatus side.

As described above with reference to the embodiments, there is provided a communication device capable of detecting whether or not the counterpart communication device connected to the communication device through a cable has a new communication function other than an existing communication function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication device comprising:
a first communication module configured to perform a first communication with a counterpart communication device to receive a video signal through a communication cable using a first set of communication lines provided in the communication cable;
a second communication module configured to confirm with the counterpart communication device through the communication cable using a second set of communication lines provided in the communication cable whether the counterpart communication device is capable of establishing a second communication being a two-way communication;
a storage module configured to store information related to an extended communication capability provided in the counterpart communication device, the extended communication capability being different from the first communication and the second communication; and
a controller configured to establish a third communication with the counterpart communication device based on the information stored in the storage module when the second communication module confirms that the counterpart communication device is capable of establishing the second communication.

2. The device of claim 1, wherein the first communication module receives the video signal transmitted in a Transition Minimized Differential Signaling, and
wherein the second communication module performs the second communication through the second set of communication lines conforming to an IIC bus interface standard.

3. The device of claim 1, wherein the second communication module is configured to allow the information stored in the storage module to be read out through the second set of communication lines conforming to an IIC bus interface standard.

4. The device of claim 1, wherein the controller controls the second communication module to perform the third communication when the third communication is available.

5. The device of claim 1, wherein the second communication module confirms with the counterpart communication device through the second set of communication lines being defined as unused lines.

6. The device of claim 1, wherein the controller supplies electrical power to the counterpart communication device through the communication cable as one of the extended communication capability.

7. A communication device comprising:
a first communication module configured to perform a first communication with a counterpart communication device to receive a video signal through a communication cable using a first set of communication lines provided in the communication cable;
a second communication module configured to perform a second communication, being a two-way communication, with the counterpart communication device through the communication cable using a second set of communication lines provided in the communication cable, the second communication module being capable of accessing an external storage module connected through the connection cable to read and write information related to an extended communication capability provided in the counterpart communication device, the extended communication capability being different from the first communication and the second communication;
a controller configured to establish a third communication with the counterpart communication device based on the information accessed by the second communication module.

8. The device of claim 7, wherein the first communication module receives the video signal transmitted in a Transition Minimized Differential Signaling, and
wherein the second communication module performs the second communication through the second set of communication lines conforming to an IIC bus interface standard.

9. The device of claim 7, wherein the second communication module is configured to access the information stored in the external storage module through the second set of communication lines conforming to an IIC bus interface standard.

10. The device of claim 7, wherein the controller controls the second communication module to perform the third communication when the third communication is available.

11. The device of claim 7, wherein the controller supplies electrical power to the counterpart communication device through the communication cable as one of the extended communication capability.
